(19) United States
(12) Patent Application Publication
(10) Pub. No.: US 2008/0206731 A1
(43) Pub. Date: Aug. 28, 2008

(54) Apparatus, Method and Computer Program for Compiling a Test as Well as Apparatus, Method and Computer Program for Testing an Examinee

(75) Inventors: Fanny Bastianova-Klett, Waltershausen (DE); Karlheinz Brandenburg, Erlangen (DE)

Correspondence Address: SCHOPPE, ZIMMERMAN , STOCKELLER & ZINKLER, C/O KEATING & BENNETT , LLP, 8180 GREENSBORO DRIVE , SUITE 850, MCLEAN, VA, 22102, US

(73) Assignee: Fraunhofer-Gesellschaft zur Forderung der angewandten Forschung e.V., Munchen (DE)

(21) Appl. No.: 11/995,563

(22) PCT Filed: Sep. 6, 2006
(86) PCT No.: PCT/EP2006/008702

§ 371 Date: Feb. 11, 2008

(30) Foreign Application Priority Data
Sep. 23, 2005 (DE) 102005045625.1

(51) Int. Cl. G09B 7/00

(52) U.S. Cl. 434/322; 707/4

(57) ABSTRACT

An apparatus for compiling a test comprises a database having a plurality of test tasks stored therein, each test task being associated with a task type, means for selecting test tasks from the database to obtain a multitude of selected test tasks, and means for outputting the selected test tasks of the test to a user. The means for selecting test tasks comprises means for selecting, for a task type, at least one test task from the database and for taking the selected test task over to the multitude of selected test tasks if a test task for the task type is available in the database, and an exception-handling logic configured to search the database, for a task type for which no test task is available in the database, for a replacement test task according to a given replacement rule and take same over to the multitude of selected tasks.

### TECHNICAL FIELD

The present invention generally relates to an apparatus, a method and a computer program for compiling a test as well as an apparatus, a method and a computer program for testing an examinee, and in particular to apparatuses, methods and computer programs enabling dynamic test compilation.

### BACKGROUND

Currently, computer-aided learning systems are enjoying continuously increasing propagation in the area of education and training. This increase in the area of computer-aided learning systems is, among others, accounted for by the substantial advances made in information technology as well as the propagation of high-speed data communication networks. Thus, electronic learning systems allow a multimedia-based communication of learning contents, wherein audiovisual elements may, for example, be employed.

Apart from the pure representation of learning contents, what is of high importance in electronic learning systems is the introduction of self-assessment. Such self-assessment assists the learner in recognizing knowledge and comprehension deficits and may therefore contribute to a systematic recapitulation of those subjects where the learner still has catching up to do. Apart from that, it is to be noted that it has been proved that self-assessment may increase the learner's motivation.

In conventional electronic learning systems, several kinds of self-assessment are known. In the simplest case, there is stored in the electronic learning system at least one fixedly compiled test, which may be worked on by the user, whereupon an evaluation will be provided that determines which questions or test tasks the learner answered correctly. Such a fixedly predetermined test may, for example, have been compiled by a human tutor, wherein the human tutor is responsible for the test being well-balanced, i.e., uniformly exacting the learner's capabilities. However, such a fixedly compiled test cannot or only insufficiently take the learner's current level of knowledge into account.

In another known method for automated test compilation there are, for example, a predetermined multitude of test questions from which then a plurality of questions are selected and compiled to form a test. In order to enable a well-balanced test, a plurality of categories may be present, wherein the number of questions per category is usually given prior to the compilation of the self-assessment test. Although the method shown serves to achieve a well-balanced test, the selection of questions is again not adapted to the learner's standard of knowledge. In addition, it is to be noted that the principle for test compilation shown usually does not enable such an adaptation to the learner's level of knowledge.

### SUMMARY

According to an embodiment, an apparatus for compiling a test may have: a database having a plurality of test tasks stored therein, wherein each test task is associated with a task type of a plurality of task types; a selector for selecting test tasks from the database so as to achieve a multitude of selected test tasks for the test, wherein the selector for selecting test tasks may have: a selector for selecting, for a task type of the plurality of task types, at least one test task from the database, and for taken the selected test task over to a multitude of selected test tasks if a test task for the task type is available in the database; and an exception handling logic adapted to search the database for a replacement test task according to a given replacement rule for a task type from the plurality of task types for which no take same over to the multitude of selected test tasks if there is a test task satisfying the invention rule in the database; and an outputter for outputting the selected test tasks of the test to a user.

According to another embodiment, a method for compiling a test using a database having a plurality of test tasks stored therein, wherein each test task is associated with a task type of a plurality of task types, may have the steps of: selecting test tasks from the database so as to achieve a multitude of selected test tasks for the test, wherein the selecting of test tasks may have the steps of: selecting, for a task type of the plurality of task types, at least one test task from the database and taking the selected test task over to the multitude of selected test tasks if a test task for the task type is available in the database; and performing exception handling for a task type from the plurality of task types for which no test task is available in the database, wherein the performing of the exception handling exhibits searching the database, according to a given replacement rule, for a replacement test task for the task type for which no test task is available in the database as well as, if there is a test task satisfying the replacement rule in the database, taking the replacement test task over to the multitude of selected tasks; and outputting the selected tasks of the test to a user.

An embodiment may have: a computer program with a program code for performing a method for compiling a test using a database having a plurality of test tasks stored therein, wherein each test task is associated with a task type of a plurality of task types, the method having the steps of: selecting test tasks from the database so as to achieve a multitude of selected test tasks for the test, wherein the selecting of test tasks may have the steps of: selecting, for a task type of the plurality of task types, at least one test task from the database and taking the selected test task over to the multitude of selected test tasks if a test task for the task type is available in the database; and performing exception handling for a task type from the plurality of task types for which no test task is available in the database, wherein the performing of the exception handling exhibits searching the database, according to a given replacement rule, for a replacement test task for the task type for which no test task is available in the database as well as, if there is a test task satisfying the replacement rule in the database, taking the replacement test task over to the multitude of selected tasks; and outputting the selected tasks of the test to a user, when the computer program runs on a computer.

According to another embodiment, an apparatus for testing an examinee may have: an apparatus for compiling a test, having: a database having a plurality of test tasks stored therein, wherein each test task is associated with a task type of a plurality of task types; a selector for selecting test tasks from the database so as to achieve a multitude of selected test tasks for the test, wherein the selector for selecting test tasks may have: a selector for selecting, for a task type of the plurality of task types, at least one test task from the database, and for taken the selected test task over to a multitude of selected test tasks if a test task for the task type is available in the database; and an exception handling logic adapted to search the database for a replacement test task according to a given replacement rule for a task type from the plurality of task types for which no take same over to the multitude of selected test tasks if there is a test task satisfying the invention rule in the database; and an outputter for outputting the selected test tasks of the test to a user; a reader for reading in a response to at least one of the selected test tasks output by the apparatus for compiling the test; an evaluator for evaluating the read-in response so as to achieve encoded information on whether the read-in response represents a correct solution of the selected test tasks output; and an outputter for outputting a test result in dependence on the encoded information.

According to another embodiment, a method for testing an examinee may have the steps of: compiling a test using a database having a plurality of test tasks stored therein, wherein each test task is associated with a task type of a plurality of task types, having the steps of: selecting test tasks from the database so as to achieve a multitude of selected test tasks for the test, wherein the selecting of test tasks may have the steps of: selecting, for a task type of the plurality of task types, at least one test task from the database and taking the selected test task over to the multitude of selected test tasks if a test task for the task type is available in the database; and performing exception handling for a task type from the plurality of task types for which no test task is available in the database, wherein the performing of the exception handling exhibits searching the database, according to a given replacement rule, for a replacement test task for the task type for which no test task is available in the database as well as, if there is a test task satisfying the replacement rule in the database, taking the replacement test task over to the multitude of selected tasks; and outputting the selected tasks of the test to a user; reading in a response to one of the selected test tasks output; evaluating the read-in response so as to achieve encoded information on whether the read-in response is a correct solution of the selected test task output; and outputting a test result in dependence on the encoded information.

An embodiment may have: a computer program with a program code for performing a method for testing an examinee, having the steps of: compiling a test using a database having a plurality of test tasks stored therein, wherein each test task is associated with a task type of a plurality of task types, having the steps of: selecting test tasks from the database so as to achieve a multitude of selected test tasks for the test, wherein the selecting of test tasks may have the steps of: selecting, for a task type of the plurality of task types, at least one test task from the database and taking the selected test task over to the multitude of selected test tasks if a test task for the task type is available in the database; and performing exception handling for a task type from the plurality of task types for which no test task is available in the database, wherein the performing of the exception handling exhibits searching the database, according to a given replacement rule, for a replacement test task for the task type for which no test task is available in the database as well as, if there is a test task satisfying the replacement rule in the database, taking the replacement test task over to the multitude of selected tasks; and outputting the selected tasks of the test to a user; reading in a response to one of the selected test tasks output; evaluating the read-in response so as to achieve encoded information on whether the read-in response is a correct solution of the selected test task output; and outputting a test result in dependence on the encoded information, when the computer program runs on a computer.

The present invention provides an apparatus for compiling a test with a database having a plurality of test tasks stored therein, wherein each test task is associated with a task type of a plurality of task types, means for selecting test tasks from the database so as to obtain an multitude of selected test tasks for the test, and means for outputting the selected test tasks of the test to a user. The means for selecting test tasks comprises means for selecting, for an task type of the plurality of task types, at least one test task from a database and for taking the selected test task over to the multitude of selected test tasks if a test task for the task is available in the database, as well as an exception-handling logic configured to search the database for an alternative test task according to a predetermined replacement rule for a task type from the plurality of task types, for which no test task is available in the database and take same over to the group of selected tasks if there is a test task satisfying the replacement rule in the database.

It is the central idea of the present invention that, by flexible selection of test tasks, wherein, using an exception-handling logic, an alternative test task for a task type for which there is no test task in the database is determined according to a predetermined replacement rule, a test compilation adapted to the knowledge of a learner or examinee may be effected. By means of rule-based selection of an alternative test task for a task type, for which there is no test task in the database, a well-balanced test may be generated even if test tasks are not available for all task types planned from a plurality of task types.

Such a situation may, for example, occur if the apparatus for compiling the test is activated before a sufficient number of test tasks regarding each task type to be processed is stored in the database, i.e. if, for example, downloading the entire database with the test tasks onto a learner's local computer consumes a comparatively large multitude of time and the apparatus for compiling the test is activated before the downloading has been completed. Furthermore, it may be that there are no more test tasks available for a task type from the plurality of task types, as those test tasks the examinee has already successfully solved are designated as not available so as to avoid repeated processing of the test tasks already successfully solved.

Therefore, the inventive concept enables a dynamic and user-adapted compilation of a test. The inventive apparatus may therefore also be regarded as a user-adapted apparatus.

The tests, which are automatically compiled, well-balanced and adapted to the level of knowledge of the user or examinee, may be utilized both for self-assessment and for assessment in the context of holding a certified examination.

The present invention therefore offers substantial advantages over known apparatuses for compiling a test. Thus, the present invention makes it possible to successfully compile a test, even if not at least one test task (or a sufficient number thereof) is present for all task types to be used, whereas conventional test systems in this case cannot compile a test combination or a well-balanced test combination, as the case may be. Determining an alternative test task for a task type for which no test task is available in the database, by means of an exception-handling logic using a predetermined replacement rule, here allows a well-defined replacement so that a well-balanced test may still be effected in an automated manner if a suitable replacement rule is given. Here, the replacement rule may use information and/or meta-information pertaining to the test tasks or task types so as to control the replacement. Thus, an optimal replacement may be ensured, even if a priori it is not known which task types are available at all.

Moreover, it is to be noted that the inventive apparatus for compiling a test enables retroactive reduction of the number of test tasks available without interfering with an automated test compilation. This may be effected, for example, by deleting test tasks or by marking test tasks as not available.

Moreover, in view of an execution of a test, a differentiation can be made between a learner and an examinee. Here, the inventive concept enables performing both a learner's self-assessment of and testing an examinee in the context of an exam situation. Here, the inventive concept may contain holding a certified examination. Therefore, a user of an inventive apparatus or of the inventive concept may be both a learner and an examinee.

Furthermore, it is advantageous that the apparatus for compiling a test further comprises availability control means configured to ensure that the means for selecting at least one test task from the database recognizes a test task as not available which the availability control identifies as already successfully solved by a user. Thus, what can be achieved is that tasks that were already successfully solved by a user are no longer considered in the test compilation. This serves to avoid a repetition of already successfully solved test tasks, whereby the learning efficiency of an electronic learning system may be substantially increased, and whereby a learner's motivation may also be efficiently increased. The availability control may, for example, be configured to add user-related information to the database indicating that the user has successfully solved a test task when the availability control means recognizes that the user has successfully solved the particular test task. The availability control means may therefore advantageously evaluate information generated in the evaluation of the responses supplied by the user.

Furthermore, it is to be noted that, in the manner shown, what can be achieved is that the database comprises both test tasks and user-related information on which test tasks have already been successfully solved by a particular user. The user-related information may, of course, be installed for several different users so that a particularly memory-efficient database system is created. This then also enables a user-individualized test compilation in a multiple-user system (such as in a client-server system).

Furthermore, the availability control means may be configured to delete a certain test task in the database when a user has successfully solved the test task. This is, for example, advantageous in portable computer systems with a limited memory capacity. As, according to the invention, it may be provided for that a test task that has once been successfully solved is not repeated, it will, of course, not be necessary to keep on storing same. This enables a resource-saving operation of an electronic learning system or an electronic learning environment.

Furthermore, it is advantageous that the inventive apparatus for compiling a test comprises means for receiving a nominal level of difficulty, wherein, furthermore, a level of difficulty is associated with each test task, and wherein the apparatus for compiling the test further comprises difficulty control means configured to ensure that the means for selecting at least a test task from the database recognizes as available only a test task, the associated level of difficulty of which deviates from the nominal level of difficulty by a predetermined level-of-difficulty deviation at the most. This serves to adapt a test executed in the electronic learning system to a learner's learning progress by means of specifying a nominal level of difficulty.

The replacement rule is advantageously configured in the inventive apparatus so as to instruct the exception-handling logic to determine a replacement task type for the task type from the plurality of task types for which no test task is available in the database, and search the database for a replacement test task of the replacement task type and take same over to the multitude of the selected tasks. It has been shown that, typically, for each task type there is a replacement task type very similar thereto, so that the use of a test task of the replacement task type (instead of a test task of the task type for which there is no test task in the database) only slightly impairs the fair balance of the test as the task types serve for training analog capabilities. In other words, replacing a task type by a similar replacement task type is typically not perceived as irritating by a human learner.

The exception-handling means may advantageously be configured to determine the replacement task type for the task type for which no test task is available by accessing a task type replacement table. It has been shown that, typically, a well-defined replacement of a task type not available by a replacement task type is useful. Such an association between a task type and a replacement task type may, for example, be stored in a task-type replacement table describing an association between the task type (to be replaced) and the replacement task type. Here, the storing of the associations between task types and replacement task types in the form of a table is very memory-efficient and in addition allows fast access.

In a further embodiment, a task-type feature vector is associated with each task type of the plurality of task types, describing for example a task type by means of at least one numerically writable criterion, better several numerically writable criteria. In this case, the exception-handling means is advantageously configured to determine a replacement task type for the task type for which there is no test task such that task-type feature vectors of the task type for which there is no test task and of the replacement task type differ as little as possible. This may, for example, be ensured by identifying, based on the task-type feature vector of the task type to be replaced, a replacement task type, the task-type feature vector of which is as similar as possible to the task-type feature vector of the task type to be replaced. Here, the similarity may be determined, for example, by an arbitrary mathematical measure of distance and/or a mathematical norm, wherein a weighting may be introduced for individual entries of the task-type feature vectors (wherein an entry of the task-type feature vector describes a characteristic property of a task type).

This serves to achieve that it suffices to describe each task type by means of one task-type feature vector. This makes a manual creation of a task-type replacement table obsolete. Rather, the task-type replacement table may be created either automatically due to the task-type feature vectors, or the task-type feature vectors may be evaluated in the manner shown whenever a replacement of a task type by a replacement task type is necessitated. This is, in turn, very advantageous in particular in connection with time-variable task databases as they may be generated, for example, by a transfer via a network interface. This is because, here, exactly those task types are used in determining the most suitable replacement task type that are in fact available in the database. Finally, the description of the task types by means of task-type feature vectors and the replacement of task types based on the task-type feature vectors is advantageous in that task types from different sources and/or tutors can thus be compared and in that subsequently a central provision of replacement rules (such as in the form of a table) is not necessary.

If a test task is associated with a level of difficulty and if the inventive apparatus further comprises means for receiving a nominal level of difficulty, then it is advantageous that the replacement rule is configured to instruct the exception-handling logic to determine, based on the nominal level of difficulty, a replacement level of difficulty and search, for the task type from the plurality of task types for which there is no test task with the nominal level of difficulty in the database, for a replacement test task, the level of difficulty of which deviates from the replacement level of difficulty by a predetermined magnitude at the most, and to take the replacement test task over to the multitude of selected test tasks. This is because it has been proved advantageous to expand the replacement rule such that a replacement test task with another (replacement) level of difficulty is identified for a task type for which there is no replacement test task at the nominal level of difficulty.

Thus, it may occur that a learner develops a particularly good understanding of a certain task type and therefore works on the task types of the nominal level of difficulty for exactly this task type particularly fast. In this case, it is advisable to select the replacement level of difficulty for a replacement test task higher than the nominal level of difficulty. Raising the level of difficulty of replacement test tasks for a task type for which the original test task with the nominal level of difficulty has already been completed may, in turn, result in a completion of the test tasks that is as uniform as possible. Moreover, such a measure may further achieve that a test is perceived as well-balanced by the learner.

On the other hand, a level of difficulty may be reduced if a certain task is not solved successfully several times or if tasks of a certain task type are not solved correctly comparatively often. In this case it is thus advisable to select the replacement level of difficulty for a replacement test task lower than the nominal level of difficulty.

It is finally to be noted that in some cases it is considerably more advantageous to search for a replacement test task with a level of difficulty other than the nominal level of difficulty rather than a replacement test task with another (replacement) task type for a task type for which there is no test task with the nominal level of difficulty in the database. This is the case if, for example, there is no replacement test task for a task type that is sufficiently similar to the task type to be replaced. That is, a learner may perceive the alteration of the level of difficulty as less irritating than the alteration of the task type.

It is further to be noted that a strategy in selecting a replacement test task (i.e. the replacement rule) may be selected differently, depending on whether the test conducted is a learner's self-assessment test or a testing of an examinee. In conducting a test with an examinee, an increased level of difficulty of a replacement test task as compared to the nominal level of difficulty may, for example, be honored by an increased number of points which the examinee may achieve by successfully answering the replacement test task. The altered level of difficulty of the replacement test task can thus be taken into account when evaluating the test.

In order to better integrate a learner into the system it may, for example, be advantageous that the exception-handling logic is configured to output a message to the user including information on using a replacement level of difficulty, if such is being used.

Furthermore, it may be advantageous that the exception-handling logic includes query means configured to output a message to the user if, for a task type for which there is no test task in the database, there is no test task satisfying the replacement rule. The enquiry means may further be configured to receive from the user an input, wherein the exception-handling logic, as a function of the input, either generates a shortened test or outputs a request for selecting a different subject area to the user and receives an input from the user, based on which such a selection is enabled. That is, if there is no test task satisfying the replacement rule, it can no longer be guaranteed that a well-balanced test will be generated. In this case it is advantageous that the apparatus for compiling a test interacts with the user so as to therefore enable the user to consent to a shortened test to be conducted by a corresponding entry. If the user does not wish a shortened test, it is further advantageous to enable the user to interactively select a test referring to another subject or subject area so as to avoid a decrease in the user's motivation. Such a configuration of the inventive apparatus for compiling a test is again particularly advantageous in connection with an electronic learning system, in which the database with the test questions is set up and/or transferred to a processing device of the user little by little.

Furthermore, it is advantageous that the means for selecting at least one test task from the database in configured to select a predetermined number of test tasks pertaining to the task type from the database for a task type from the plurality of task types, if a sufficient number of test tasks are available in the database for the task type. Such a configuration may ensure that the number of test questions are in a balanced ratio to various task types. The apparatus for compiling a test may, for example, see to it that only one or a few test tasks of a time-consuming task type are selected, whereas a predetermined number of test tasks regarding another task type that can be worked on faster are selected. The serves to ensure a particularly well-balanced compilation of a test. The predetermined number of tasks may, for example, be provided by means for receiving information on a number of tasks based on the information received on the number of tasks.

A random selection of test tasks, for example using a random number generator, may also result in particularly well-balanced tests, wherein predictability may be avoided in conducting the test repeatedly. This enables a more objective evaluation of the actual level of knowledge of a learner.

Furthermore, it is advantageous to integrate the inventive apparatus for compiling a test into an apparatus for testing an examinee. The apparatus for testing an examinee further advantageously comprises means for reading in a response to at least one of the selected test tasks output by the apparatus for compiling the test. Furthermore, the apparatus for testing an examinee advantageously comprises means for evaluating the read-in response so as to obtain encoded information on whether the read-in response represents a correct solution of the selected test task output. Furthermore, it is advantageous that the apparatus for testing an examinee comprises means for outputting a test result as a function of the encoded information.

A respective apparatus for testing an examinee may, therefore, serve to conduct a test beginning with a test compilation up to a representation of the test result in a completely automated manner, wherein, again, the result will be the inventive advantages of a test compilation with exception handling using replacement rules.

Furthermore, it is advantageous that the availability control means, which determines when a test task stored in the database is available for the means for selecting at least one test task from the database, is configured to evaluate the encoded information on whether the read-in response represents a correct solution of the selected test task output. Here, it is advantageous to store the encoded information, which may, for example, contain a two-valued statement as to whether the user has successfully solved a certain test task, in a database in a user-related manner. Such a configuration results in a particularly advantageous electronic test system, in which it is ensured that a test task once solved is not output to the user a second time. This serves to achieve efficient learning, and further prevents a user from losing their motivation due to a repetition of tasks they have already solved.

The number of times a task was not solved may also be stored so as to trigger a respective system reaction. Such a system reaction may, for example, be an increase or decrease of the level of difficulty, as has already been explained above.

Furthermore, it is advantageous that the means for evaluating the read-in responses comprise comparison means configured to compare the read-in response to a comparison response stored in the database and pertaining to the selected test task output so as to evaluate the read-in response as a correct response when the read-in response deviates from the comparison response by a predetermined deviation at the most, and so as to provide encoded information corresponding to the comparison result for the selected test task output. In other words, it was recognized that the evaluation of the user entries may again be effected in an automated manner. In order to avoid excessive misinterpretation of responses of the user or learner, it is advantageous to allow a predetermined deviation between the user's response and a comparison response stored in the database. The deviation may, for example, be defined by a numerical value. In addition to that, e.g. for questions necessitating more complex responses, a predetermined deviation between a response input and the comparison response may be tolerated. This may, for example, be the case if a user is requested to make an extensive text entry. What is important here is that there is a description mode that makes a deviation of a response from the comparison response quantifiable.

Furthermore, it is in some cases advantageous to accept a response as a correct response only if the read-in response matches the comparison response. This may be advantageous, for example, in multiple-choice test tasks and enables particularly advantageous electronic evaluation, for example by means of comparison means.

In the case of larger-scale deviations between a correct response and a response input by the user and if the user does not solve a test task, the inventive apparatus for compiling a test may further output references to relevant subjects and/or to weak points of the user (of the learner or the examinee).

### BRIEF DESCRIPTION OF THE DRAWINGS

Embodiments of the present invention will be detailed subsequently referring to the appended drawings, in which:

FIG. 1 is a flowchart of an inventive method for compiling a test according to a first embodiment of the present invention;

FIG. 2 is a graphic representation of an exemplary database entry for a test task;

FIG. 3 is a flowchart of an inventive method for determining the test tasks available;

FIG. 4A is a first part of a flowchart of an inventive method for compiling a test according to a second embodiment of the present invention;

FIG. 4B is a second part of a flowchart of an inventive method for compiling a test according to the second embodiment of the present invention;

FIG. 5A is a flowchart of an inventive method for identifying a replacement test task in a test-task database using a replacement-test-task table;

FIG. 5B is a graphic representation of a replacement-test-task table;

FIG. 6A is a flowchart of an inventive method for identifying an allowable replacement task type;

FIG. 6B is a graphic representation of a task-type feature vector;

FIG. 7 is a flowchart of an inventive method for identifying a replacement task type according to a third embodiment of the present invention;

FIG. 8 is a flowchart of an inventive method for conducting a test according to a fourth embodiment of the present invention; and

FIG. 9 is a flowchart of an inventive method for conducting a test according to a fifth embodiment of the present invention.

### DETAILED DESCRIPTION

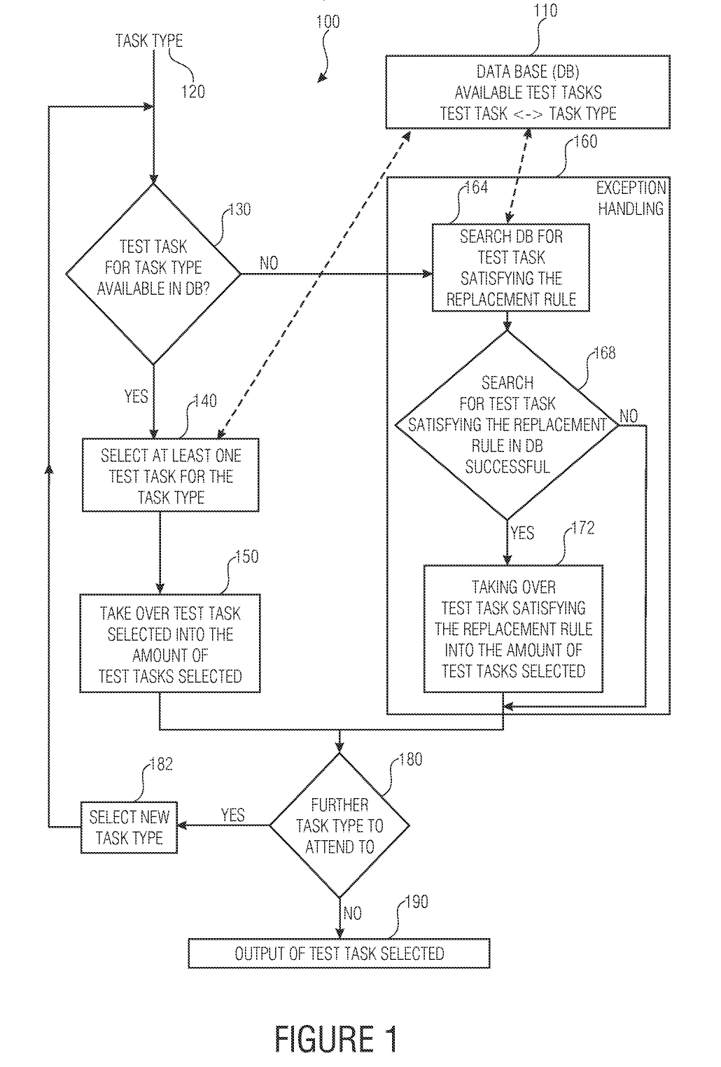

FIG. 1 shows a flowchart of an inventive method for compiling a test according to a first embodiment of the present invention. The flowchart of FIG. 1 is in its entirety designated with 100. The inventive method is configured to select test tasks from a database. The database is here designated with 110 and comprises a plurality of available test tasks. Furthermore, it is to be noted that there is an association between test tasks and task types. In other words, each test task in the database is, for example, associated with a task type. Each test task in the database, for example, has its own associated field or an associated entry, respectively, which describes the task type. It is equally possible that there are several tables or sub-databases, respectively, in the database, wherein only test tasks of the same type are stored in a table or sub-database, respectively. In summary, the data structure of the database is configured such that there is an association between test tasks and task types.

Furthermore, it is to be noted that there may be a difference between the tasks present in the database and the tasks available in the context of the algorithm described herein. In other words, one or more tasks in the database may be marked as not available. The database may, for example, comprise a flag determining that a test task is not available. This flag may, for example, be set when the user has already successfully solved a task. Moreover, it is to be noted that, depending on the event, tasks in the database may be filtered out as available tasks, wherein available tasks must typically comply with a condition and/or a logical link consisting of several conditions.

The function of the algorithm shown with respect to FIG. 1 consists in compiling a test that is as well-balanced as possible and typically comprises a plurality of task types and at the same time enabling an exceptional case to be handled in which no test task is available in the database for a task type.

The algorithm shown receives at least one task type 120 of a test task to be searched for in the database as an input quantity. In a first step 130, the algorithm shown then investigates whether a test task of the given task type 120 is available in the database. This may, for example, be effected by filtering the test tasks available in the database 110. Furthermore, the database may also be configured to record how many tasks of different task types are available. In other words, the database may, for example, comprise a counter pertaining to a task type, which indicates the number of test tasks available and pertaining to the task type.

If a recognition is made in the first step 130 that at least one test task is available in the database for the given task type 120, at least one test task for the given task type 120 is subsequently selected in a second step 140. Here, a test task for the given task type 120 is, for example, searched for in the database. The first task found in the database for the given task type 120 may, for example, be used. Furthermore, it is possible to select one or more test tasks from a plurality of test tasks available in the database 110 for the given task type 120 in a random fashion, i.e., for example, using a random number generator. In addition it is to be noted that the step 130 of checking whether a test task for the task type is available in the database and the step 140 of selecting at least one test task for the task type may be very closely correlated with each other. Thus it may be attempted to select a test task from the database 110. If the selecting is not successful, then it may in this case be determined that there is no test task available in the database for the given task type 120.

If at least one test task for the task type is selected in the second step 140, then the test task selected may be taken over to a multitude of selected test tasks in a third step 150.

On the other hand, an exception handling 160 may be effected if it is determined in the first step 130 that there is no test task available in the database for the given task type 120. If this is the case, a test task satisfying a given replacement rule is searched for in the database in a step 164. Here, the replacement rule provides instructions as to which criteria a replacement test task substituting a test task of the task type 120, for which no test task is available in the database, must fulfil. Here, the replacement rule may, for example, express that a replacement test task of a replacement task type may be used for a given task type 120, for which no test task is available in the database.

Here, the replacement rule may, for example, determine one or more criteria, according to which test tasks in the database 110 are classified as available. In other words, the test task may also specify a filter, by means of which the database 110 is searched through for tasks available. The filter for the database search given by the replacement rule is advantageously wider than an original filter used to determine whether a test task for the task type is available in the database. Instead of a wider filter, an altered filter (where, for example, the task type 120 given is replaced by a replacement task type) may also be defined by the replacement rule. Here, the replacement rule may, of course, be specific for a given task type 120.

If it is determined in a step 168 that a task was found in the database 110 in the step 164, which is compliant with the given replacement rule, then the test task found, which complies with the replacement rule, is transferred to the multitude of selected test tasks in a further step 172. If, however, no replacement test task compliant with the replacement rule is found in the database 110, the exception handling 160 is terminated without taking a test task over to the multitude of selected test tasks.

Furthermore, it is to be noted that the replacement rule may by all means be a multi-stage replacement rule. In other words, the multi-stage replacement rule may include several partial replacement rules, which are handled with descending priority. In other words, a partial replacement rule with lower priority is not employed until a replacement rule with higher priority does not provide a result. In this manner, a filter used for the evaluation of the database 110 may be extended and altered in a step-wise manner for a search for a replacement test task. Thus it can be achieved that less advantageous replacements of a test task by a replacement test task (according to a less advantageous partial replacement rule of lower priority) do not occur unless advantageous replacements (according to a advantageous partial replacement rule of higher priority) are not possible.

Finally, it is to be noted that the flowchart 100 shown in FIG. 1 may be configured for a plurality of task types. After taking the selected test task over to the multitude of selected test tasks in the third step 150 or after executing the exception handling 160, a advantageous verification is thus effected in a check step 180 whether a further task type is to be processed. If this is the case, a new task type is selected in a step 182 and the method shown is repeated. If all task types to be handled are processed, then the selected test tasks are finally output in an output step 190. Here, the selected test tasks may, for example, be output visually and/or acoustically and/or tactilely to a user. The test tasks may further be printed or optionally be stored on a data carrier for use by a user. Thus, the selected test tasks output relative to the user are determined by the sequence of the algorithm 100 described.

If no test task suitable for the task type 120 to be used is present, the user is presented with a replacement test task selected according to the replacement rule. Thus, it can be ensured that an optimal compilation of test tasks, in which the selection of task types is as balanced as possible, will be made available. Furthermore, it can be guaranteed that a certain number of test tasks will be output relative to the user, even if there are no more test tasks available for individual task types.

Thus, the inventive method enables automatic generation of tests that are compiled in a manner that is well-balanced and/or user-adapted, wherein the exception handling 160 is well defined by at least one given replacement rule.

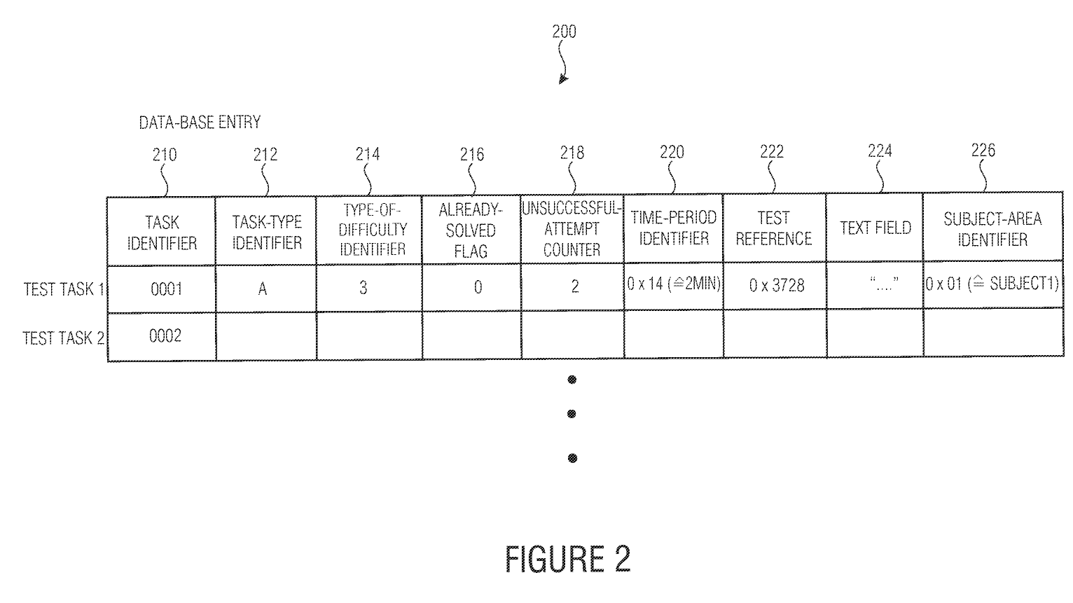

FIG. 2 shows a graphic representation of an exemplary database entry for a test task. The exemplary database entry is in its entirety designated with 200. Here, the database comprises entries for a plurality of test tasks, two of which are shown in FIG. 2. The database entries shown here are otherwise to be considered as exemplary, wherein individual entries may be omitted in an actual implementation. On the other hand, additional entries may be added.

In a database, it is advantageous that a unique task identifier 210, for example in the form of a consecutive number, is associated with each test task. Furthermore, it is advantageous that a task-type identifier 212 (e.g. “A”) is associated with a task. Here, the task-type identifier 212 may, for example, describe the type of the task (such as sorting task, multiple-choice task, image-lettering task, calculation task, . . . ). Furthermore, the database entry may comprise a level-of-difficulty identifier 214 concerning a test task, which advantageously represents a difficulty of the task in the form of a numerical value. Furthermore, the database entry advantageously comprises an already-solved flag 216 indicating whether a task has already been successfully solved by a user. The already-solved flag may, for example, be a binary and/or Boolean entry. Furthermore, the database entry may comprise an unsuccessful-attempt counter 218 pertaining to a user, which, for example, indicates how often a user has solved a task without success or with the wrong result, respectively.

In addition to that, the database entry may comprise a period identifier 220 having a working time permissible and/or taken for a task entered therein in encoded form. Finally, the database entry 200 may also comprise a reference 222 to a text pertaining to the respective test task or to other information pertaining to the test task (e.g. images, audio information, animations or other multimedia information), wherein the text or the other information may be considered as more profound information. It is also possible that the database entry 200 comprises a text field 224 having a task text or at least a caption of the task directly entered therein. Finally, an encoded subject-area identifier 226 may also be part of the database entry 200. The information in the database entry 200 of a test task may be used in a search in the database so as to select available tasks and further enable an indication and evaluation of the respective test tasks.

It is further to be noted that, for example in a multi-user environment, the already-solved flag 216 and the unsuccessful-attempt counter 218 may be individually stored in a separate table for a plurality of user so that the already-solved flag 216 and the unsuccessful-attempt counter 218 represent user-specific information associated with a user.

Furthermore, it is to be noted that a database entry 200 regarding a task may also comprise numerous further fields. Thus, a database may comprise references to help texts and further information. Furthermore, the database entry 200 may also comprise additional information relevant for an evaluation of the task, such as information on a correct response or on a number of points an examinee may obtain by solving the task correctly. All these pieces of information may be used both in selecting the task and in the later output of the task and in the subsequent evaluation of a user input.

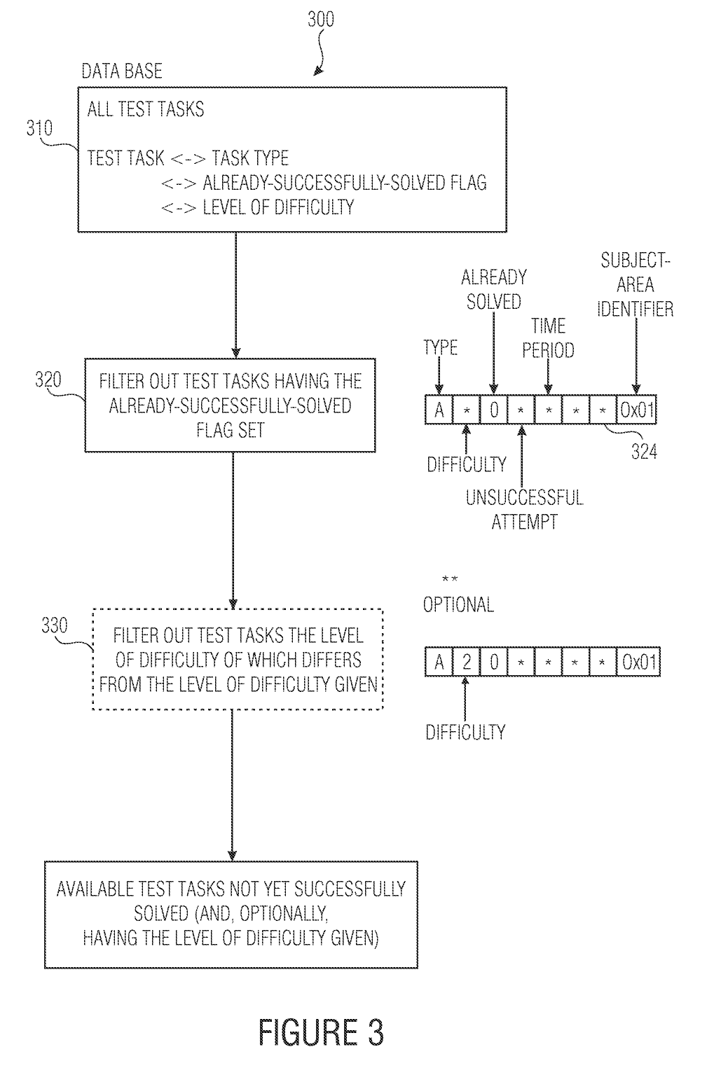

FIG. 3 shows a flowchart of an inventive method for determining the test tasks available from a database comprising all test tasks (split up into several tables for different task types, as the case may be). The inventive method is in its entirety designated with 300. Here, it is assumed that a database 310 comprises a complete set of test tasks, wherein at least one task type, one already-successfully-solved flag as well as one level of difficulty is associated with each test task. In the first step 320, those test tasks where the already-successfully-solved flag is set are filtered out of the database 310. In the first step 320, appropriately determining a filter 324 further ensures that only tasks of the task type currently to be processed (for example of the task type “A”) are considered. The filter 324 may further be configured such that a subject-area identifier (e.g. the subject-area identifier “0x01” describing subject 1) is also evaluated so that only tasks of the desired subject are selected. The filter 324 may further be configured so that a subject-area identifier (e.g. the subject-area identifier “0x01” describing subject 1) is also evaluated so that tasks of the desired subject only are selected. Finally, it is advantageous that the already-successfully-solved flag is set to “0” in the filter 324 so that only tasks not yet successfully solved by the user are read out. The other fields of the database entry 200 may, for example, not have to be considered in the filtering and may, for example, adopt an arbitrary value (indicated by an asterisk “*”).

If a level of difficulty of the test tasks is also considered, a respective additional filtering may be applied in a second step 330 so that test tasks, the level of difficulty of which differs from the given level of difficulty, may be filtered out and/or are not taken over to the multitude of available tasks. Here, it is to be noted that the consideration of the level of difficulty is optional in the second step 330. If a consideration of the level of difficulty is intended, the first step 320 and the second step 330 may also be effected in a combined manner. Following the filtering steps 320, 330, a multitude of available test tasks not yet successfully solved are then available. This multitude of test tasks may, for example, be described by a list of task identifiers 210. Equally, the multitude of available test tasks not yet solved may also comprise a copy of database entries 200. In addition, it is also to be noted that it is not mandatory that a multitude of available test tasks be explicitly provided as long as it is ensured that it is the test tasks classified as available that are considered in a further processing.

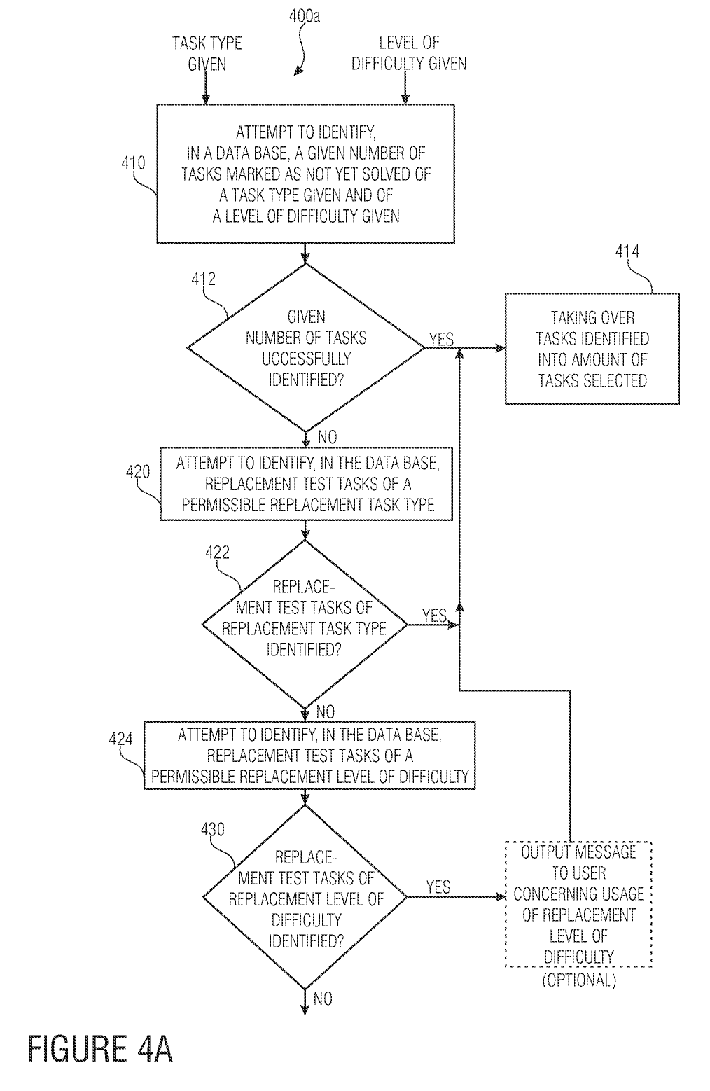

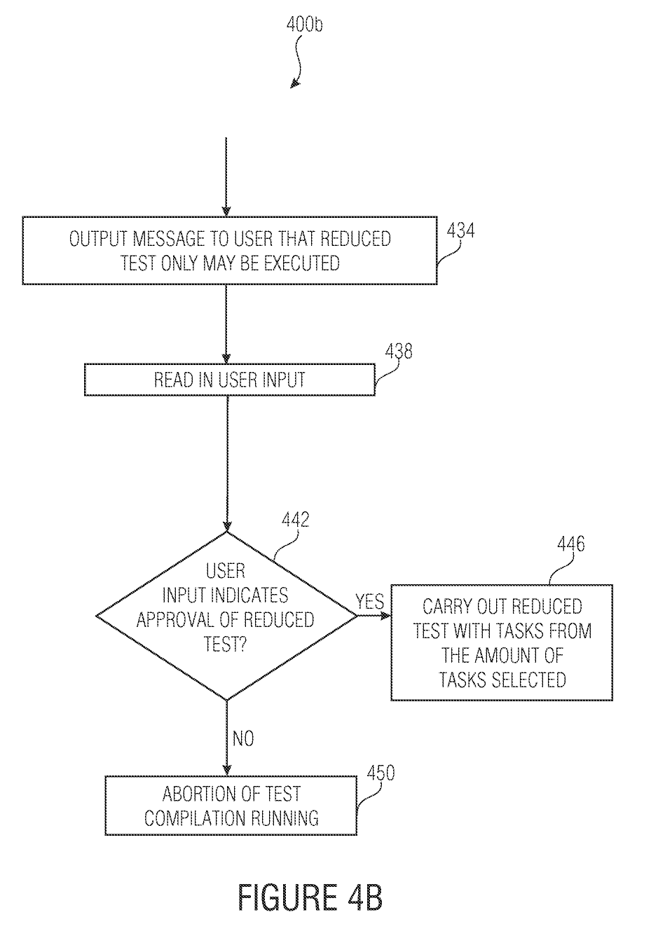

FIGS. 4A and 4B show a first part and a second part of a flowchart of an inventive method for compiling a test according to a second embodiment of the present invention.

FIGS. 4A and 4B here show a method enabling exception handling when selecting test tasks for a task type. Here, it is to be noted that the method shown in FIGS. 4A and 4B may be passed through several times for different task types in the context of an inventive test compilation. Furthermore, it is to be noted that for a given task type either only one task or a given number of tasks may be searched for, wherein the given number may vary for different task types.

The method for compiling a test with hierarchical exception handling as shown in FIGS. 4A and 4B is designated with 400A or 400B. Here, in a first step 410, an attempt is made to identify in a database a given number of tasks of the given level of difficulty marked as not yet solved.

If a determination is made in a step 412 that the given number of tasks (advantageously exactly one task) has successfully been identified, then the identified tasks are taken over to the multitude of selected tasks in a step 414. Following step 414, the method shown may be repeated for another task type until all task types to be processed have been worked on. By taking identified tasks over to the multitude of selected tasks, a test to be output to a user is thus created.

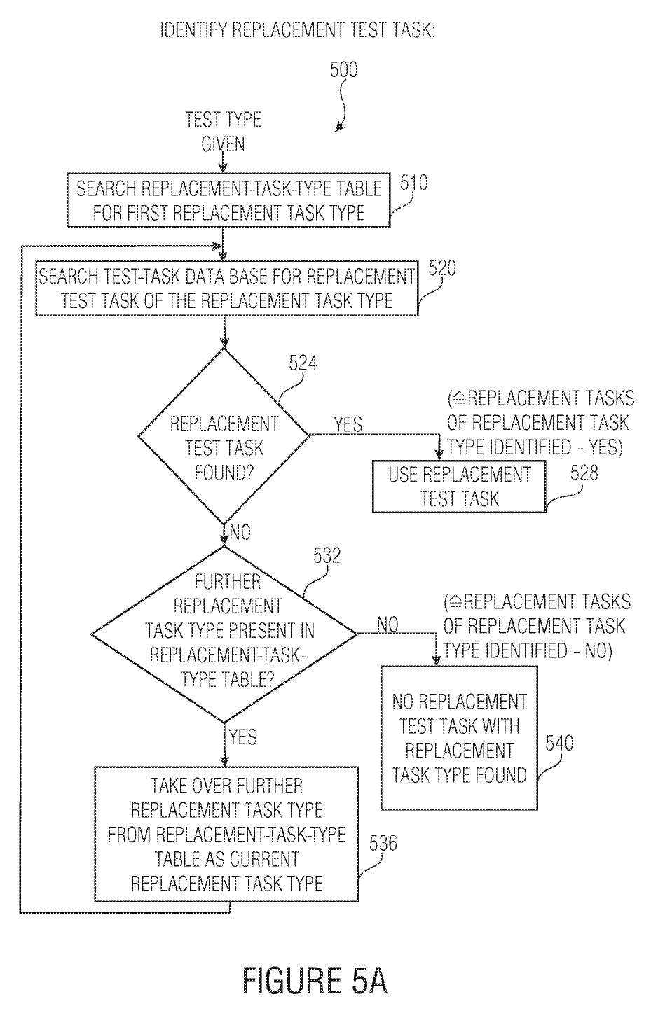

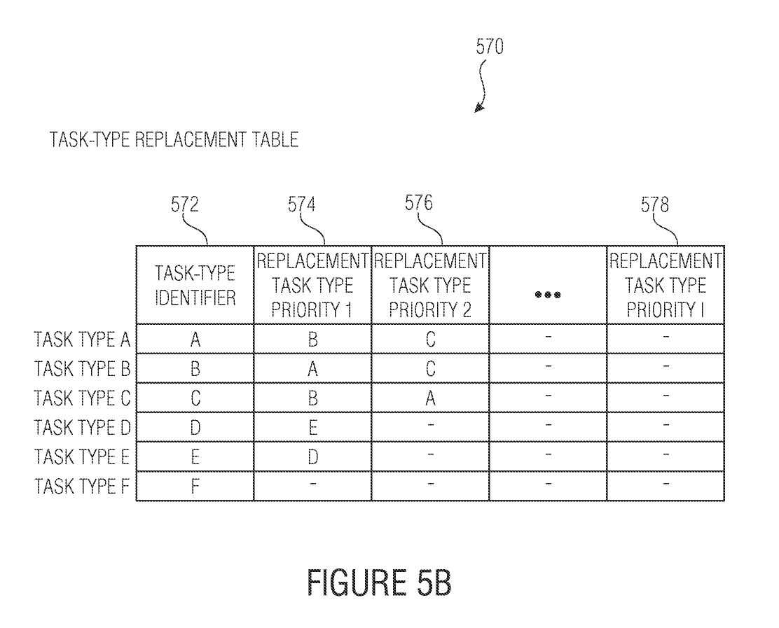

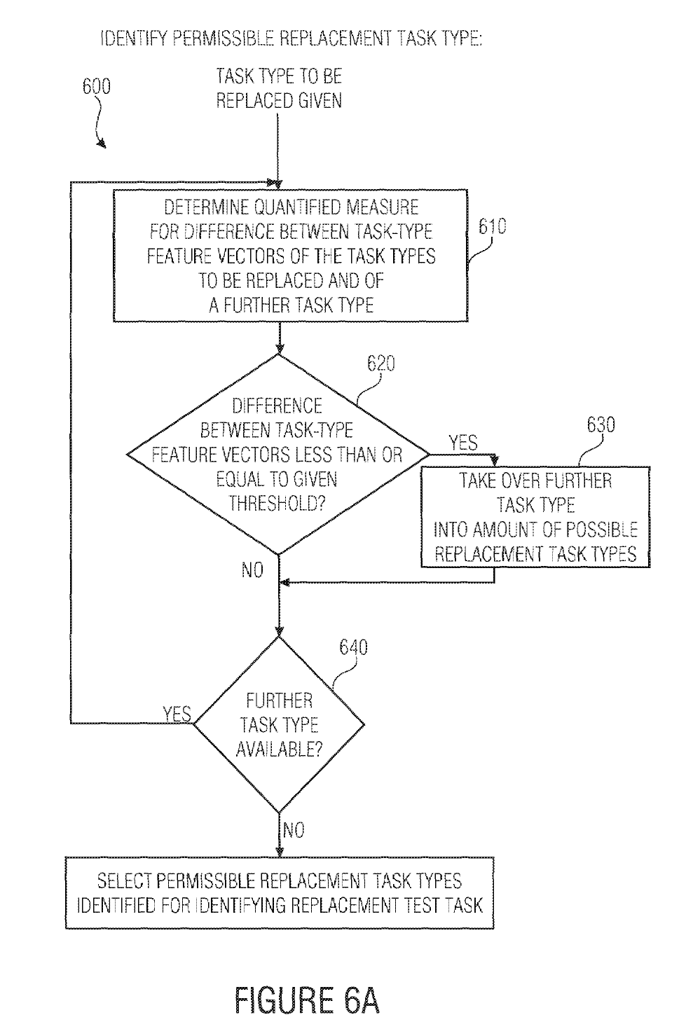

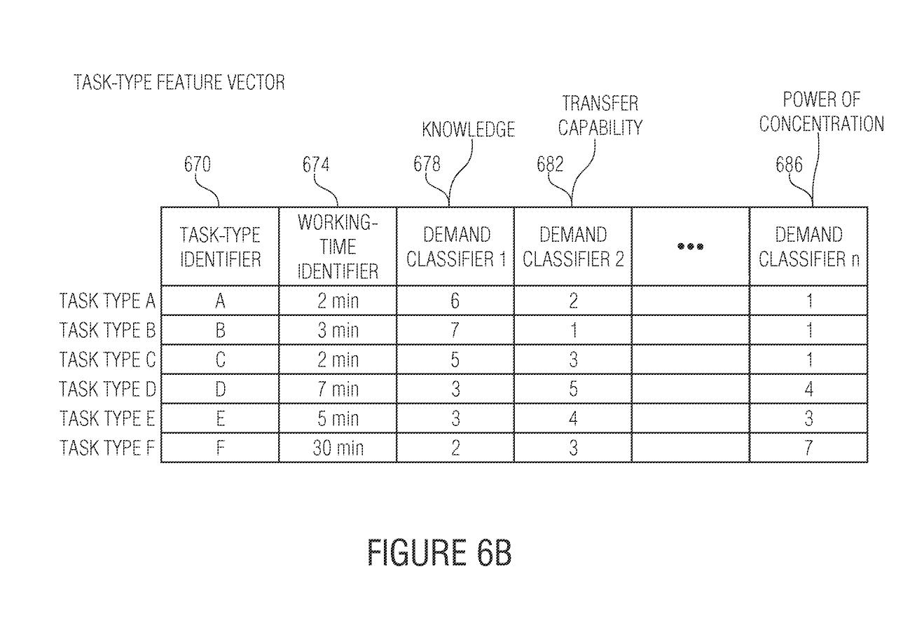

If, however, it is determined in step 412 that, for a given task type and a given level of difficulty, the given number of test tasks is not available in the database (i.e., for example, not at least one test task), then an attempt is made in a step 420 to identify at least one replacement test task of a permissible replacement task type or from a multitude of several permissible replacement task types in the database. Here, all task types present in the database may be used as permissible replacement task types, or one or more replacement task types may be determined for the given task type by means of a replacement rule. Selecting replacement task types is otherwise explained in greater detail below with respect to FIGS. 5A, 5B, 6A and 6B.

If one or more replacement test tasks of the replacement task type or from the multitude of several permissible replacement task types can be identified, the identified replacement test tasks will in turn be taken over to the multitude of selected test tasks in the step 414, and the execution of the algorithm is repeated for a further task type from the multitude of task types to be processed until all task types to be processed have been worked on. If, however, it is determined in the step 422 that for the replacement task type or the multitude of identified replacement task types identified in the step 420 no replacement test task of the given level of difficulty marked as not yet solved is available in the database (and/or that sufficient replacement test tasks are not available), an attempt is made in a step 424 to identify replacement test tasks with a permissible replacement level of difficulty in the database. In other words, a permissible replacement level of difficulty is derived from the given level of difficulty. Here, it may, for example, be assumed that, if no permissible replacement test tasks are available in the database for a given level of difficulty, replacement test tasks with a level of difficulty other than the given one are to be identified. Here, it may, for example, be determined that the replacement level of difficulty may be greater than the given nominal level of difficulty by a given deviation, for example a level-of-difficulty stage. A given nominal level of difficulty and/or replacement level of difficulty may here also comprise an interval of levels of difficulty. Furthermore, several levels of difficulty (or, respectively, intervals of levels of difficulty) may successively be checked so as to identify a replacement test task with a permissible replacement level of difficulty in the database in the step 424.

Furthermore, it is to be noted that in the step 424 either only test tasks in the database of the given task type or test tasks with one or more additional replacement tasks types may additionally be taken so as to identify a replacement test task.

If, therefore, it is determined in the step 430 that in the step 424 a replacement test task with the given task type and the replacement level of difficulty or (optionally) a replacement test task with a permissible replacement task type and a permissible replacement level of difficulty could be identified, then the identified test task is in turn taken over to the multitude of selected tasks in the step 414. In this case, the output of a message to the user may furthermore be initiated so as to indicate to the user that a test task with a replacement level of difficulty was used. The respective output must, however, be regarded as optional. The output may further be effected directly in the compilation of the test or afterwards, when the respective replacement test task with the replacement level of difficulty is output to the user.

If, however, no test task with the replacement level of difficulty and the given task type or, as the case may be, a permissible replacement task type may be identified, then a message is output to the user in a step 434 that a only reduced test may be effected. Following this, a user's input is read in in a step 438. If the user's input read in step 438 indicates that the user agrees with a reduced test, test tasks of other task types to be used will be selected and taken over to the multitude of selected tasks if necessary, wherein again the same method is used. If test tasks and/or replacement test tasks for all task types to be processed are taken over to the multitude of selected tasks, a reduced test with tasks from the multitude of selected tasks is finally performed in a step 446.

If, however, the user's input read in the step 438 indicates that the user does not agree with a reduced test, the test compilation in process is aborted in a step 450. Following this, a user may, for example, select a different subject area, or the test compilation may be repeated after the expiration of a given waiting period. The latter possibility is advantageous if it is to be assumed that new test tasks may be added to the database of test tasks so that, as the case may be, sufficient test tasks will be available after expiration of the waiting time. Repeating the test compilation after expiration of a waiting time, which may, for example, be determined by timing means, thus enables execution of a complete test as soon as sufficient test tasks are available.

FIG. 5A shows a flowchart of an inventive method for identifying a replacement test task with a replacement task type in a test-task database using a replacement-task-type table. The method shown in FIG. 5A is in its entirety designated with 500. For performing the method 500, it is assumed that a replacement-task-type table (also termed task-type replacement table) is present as is shown, for example, in FIG. 5B. An inventive task-type replacement table describes one or more replacement task types for each task type. Here, the arrangement of the replacement tasks types in the table typically determines a priority in checking the replacement task types and/or in searching for replacement test tasks with a replacement task type. Furthermore, it is to be noted that it is possible that there is no replacement task type for a certain task type.

Thus, according to the task-type replacement table, no replacement task type, exactly one replacement task type or a plurality of replacement task types may be associated with a given task type, wherein the replacement task types typically comprise a sequence and/or different priorities. A task-type replacement table may be realized in the form of a conventional table but also, for example, as a linked-up list.

Furthermore, it is to be noted that the method 500 shown for example describes the steps 420 and 422 of the method 400A, 400B.

Thus, the method 500 is performed when the given number of tasks of the given task type and the given level of difficulty marked as not yet solved have not been identified in the database. In this case, a first replacement task type is searched for in a replacement task-type table (or task-type replacement table) in a first step 510. If the first replacement task type is found in the replacement-task-type table, then the first replacement task type is taken over as a current replacement task type, and thus a replacement test task of the first replacement task type is searched for in the test-task database in a second step 520. If it is determined in a third step 524 that a replacement test task of the first replacement task type was found, the replacement test task may be used, i.e., for example taken over to the multitude of selected tasks in a fourth step 528. If, however, no replacement test task of the first replacement task type is found, a check is made in a fifth step 532 whether a further replacement task type is present in the replacement-task-type table. If this is the case, the further replacement task type from the replacement-task-type table is taken over as a current replacement task type in a sixth step 536, and the method is repeated with the new current replacement task type in the manner shown. Again, a replacement test task of the new current replacement task type is searched for in the test-task database.

If, however, it is ascertained in the step 532 that no further replacement task type for the given task type is present in the replacement task-type table, then the method shown is aborted with the step 540, wherein a superordinated algorithm is advantageously informed of the fact that no replacement test task of a permissible replacement task type was found.

In other words, in the inventive method 500 a check is made for one or more replacement task types stored in the replacement task-type table, if a replacement test task is available in the test-task database. The sequence in which the possible replacement task types for a given task type are processed is in turn determined by the replacement-task-type table.

Furthermore, it is to be noted that there may be no replacement task type, one replacement task type or several replacement task types for a given task type. Furthermore, it is possible that for one task type all other task types may serve as replacement task types. Depending on the circumstances, the task-type replacement table may therefore be encoded in different ways. A conventional table with a given number of columns may, for example, be used. Just as well, however, a linked list may be used for storing the replacement task-type table. Apart from that, the replacement-task-type table may also be described by another form of description (such as “all except given task type”). The replacement-task-type table may otherwise be given statically or may automatically be updated when adding new task types.

FIG. 5B shows an exemplary replacement task-type table (also referred to as task-type replacement table). The task-type replacement table of FIG. 5B is in its entirety designated with 570. The task type is again described by a task-type identifier 572 (such as “A”, “B”, “C”, . . . ). For one task type (such as the task type “A”), there will be a number of replacement task types 574, 576, 578 (such as task types “B” and “C”) which are, sorted according to priority, entered in the replacement-task-type table. It goes without saying that not all fields of the replacement-task-type table must be filled in. In the example shown, the task type “A” is advantageously replaced by the task type “B”. If there is no replacement test task for the task type “B”, furthermore an attempt is made to replace the task type “A” by the task type “C”. Similarly, the task type “B” is advantageously replaced by the task type “A” and by the task type “C” if a replacement by the task type “A” is not possible. The task type “D” may be replaced by the task type “E” only and vice versa. For the task type “F” there is no permissible replacement task type according to the exemplary replacement-task-type table 570, i.e., the task type “F” cannot be replaced by a replacement task of another task type.

FIG. 6A furthermore shows a flowchart of an inventive method for identifying a permissible replacement task type for a given task type. The method shown in FIG. 6A is in its entirety designated with 600. Here, it is assumed that task types are described by task-type feature vectors, i.e., that each task type is associated with a task-type feature vector. Furthermore, it is assumed that there is a method for determining, between two given task-type feature vectors of different task types, a quantitative measure for a difference. Here, individual features of the task-type feature vector may be differently weighted. In addition, it is to be noted that the task-type feature vector may also be a scalar (i.e., a vector with only one entry). A task-type feature vector advantageously describing several numerically expressible criteria is particularly well suited for processing by means of electronic computing machinery. A distance function may advantageously provide the difference between two task-type feature vectors in the form of a numerical value or a discretely expressible distance information, wherein calculating the distance function may, for example, be effected by evaluating a mathematical norm.

According to the inventive method 600, the task-type feature vector associated with a given task type to be replaced (for which no test task is available in the database) is determined. Same may, for example, be taken from a table or extracted from the information stored in the database and pertaining to the task type. A further task-type feature vector is then similarly determined (again advantageously from a table) for a potential replacement task type. Thereupon, a quantitative measure for a difference between the task-type feature vector of the task type to be replaced and the potential replacement task type is determined in a step 610. If, furthermore, it is determined in a step 620 that a difference between the task-type feature vectors of the task type to be replaced and the potential replacement task type is less than or equal to a given threshold, then the potential replacement task type is taken over to a multitude of possible replacement task types in a step 630.

Thereupon, a check is made in a step 640 whether a further potential replacement task type is available. If this is the case, the method described will be repeated, i.e., a quantitative measure for the difference between the task-type feature vectors of the task type to be replaced and the further potential replacement task type is again determined. If, however, it is discovered in the step 640 that no further potential replacement task type is available, then the task types taken over to the multitude of the possible replacement task types are used for identifying a replacement test task.

It is to be noted here that the possible replacement task types may, for example, additionally be brought into a sequence such that a possible replacement task type, the task-type feature vector of which differs least from the task-type feature vector of the given task type to be replaced, is used with highest priority, whereas other possible replacement task types differing to a greater extent from the task type to be replaced according to their task-type feature vector are used with lesser priority. Furthermore, it is to be noted that the possible replacement task types may, for example, be entered in a table or a linked list.

Furthermore, it is to be noted that FIG. 6B shows an exemplary graphic representation of a table of task-type feature vectors for different task types. In the example given, a task-type feature vector for a given task type comprises, for example, a task-type identifier 670, a working-time identifier 674 describing a working time intended for dealing with the task type as well as several demand classifiers 678, 682, 686.

The demand classifiers 678, 682, 686 describe in encoded form or in the form of numerical values different demand categories a task type makes on a user. Thus, it may, for example, be described how high the demands made by a task type on the user are regarding knowledge, regarding the capability for transfer and/or regarding the power of concentration. It is to be noted that, for creating a task-type feature vector, one single feature of the described features of a task type (such as the working time only) or an arbitrary combination of features may be used. Based on the task-type feature vectors, ascertaining a mathematically and/or algorithmically defined measure of distance serves to determine which task types may be replaced by which other task types. In general, a replacement is possible when differences between task-type feature vectors of different task types are sufficiently small (i.e. smaller than a given maximum difference). The demand categories of the demand classifier may further optionally comprise e.g. demands regarding the ability to communicate or regarding usage of propositional logic and/or abstract logic.

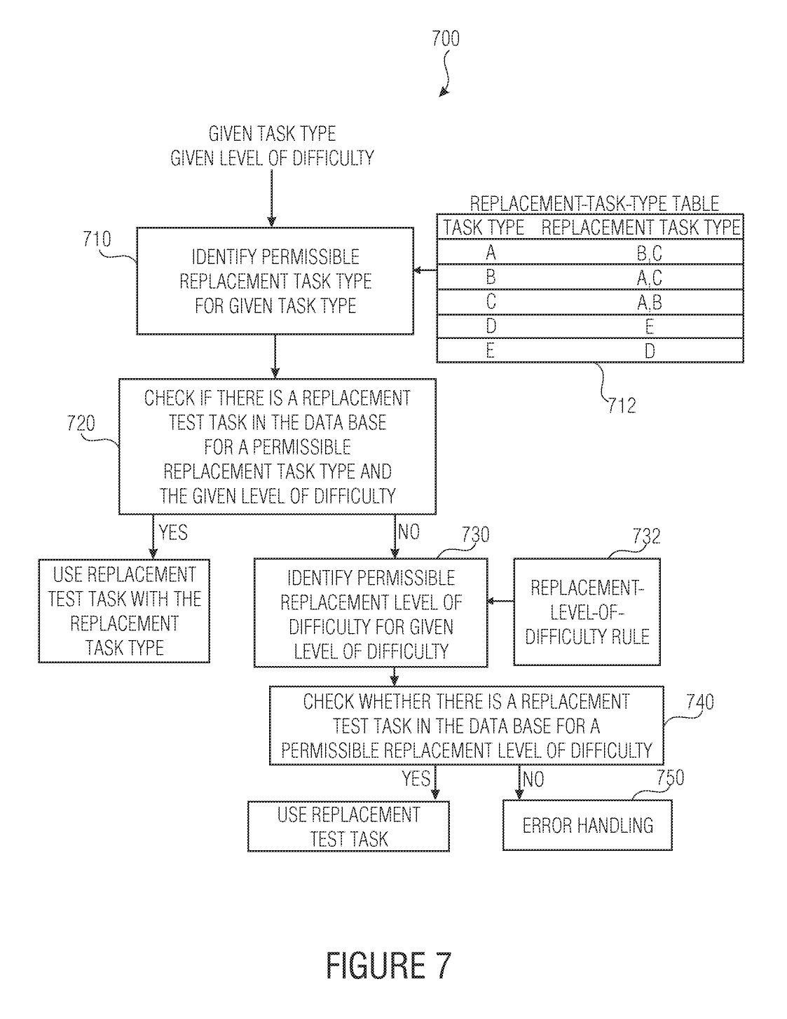

FIG. 7 shows a flowchart of a further inventive method for identifying a replacement task type according to a third embodiment of the present invention. The method shown in FIG. 7 is in its entirety designated with 700. It is assumed here again that a task type and a level of difficulty are given, wherein no test task is available in the database of test tasks for the given task type and the given level of difficulty. Thus, a permissible replacement task type for the given task type is determined in a first step 710, for which a replacement-task-type table 712 may, for example, be used. In a further step 720, a check is made as to whether there is a replacement test task in the database of test tasks for an identified permissible replacement task type and the given level of difficulty. If this is the case, the replacement test task with the replacement task type and the given level of difficulty is used, i.e., taken over to the multitude of selected tasks.

If no replacement test task is available in the database for the permissible replacement task type and the given level of difficulty, a permissible replacement level of difficulty for the given level of difficulty is ascertained in according to a replacement level-of-difficulty rule 732 a step 730. Thereupon, a check is made in a step 740 whether there is a replacement test task in the database for the permissible replacement level of difficulty, wherein either only the given task type or a multitude of permissible replacement task types is also further checked. If there is a replacement test task in the database for a permissible replacement level of difficulty, then the identified replacement test task will be used, i.e., taken over to the multitude of selected tasks. If, however, there is no replacement test task in the database for the permissible replacement level of difficulty, further error handling 750 will be performed. The further error handling 750 may, for example, comprise an output to a user and a query whether the user agrees to performing a shortened test. Furthermore, it is to be noted that, if a replacement test task with a permissible replacement level of difficulty is used, the user may be notified by outputting a message to the user.

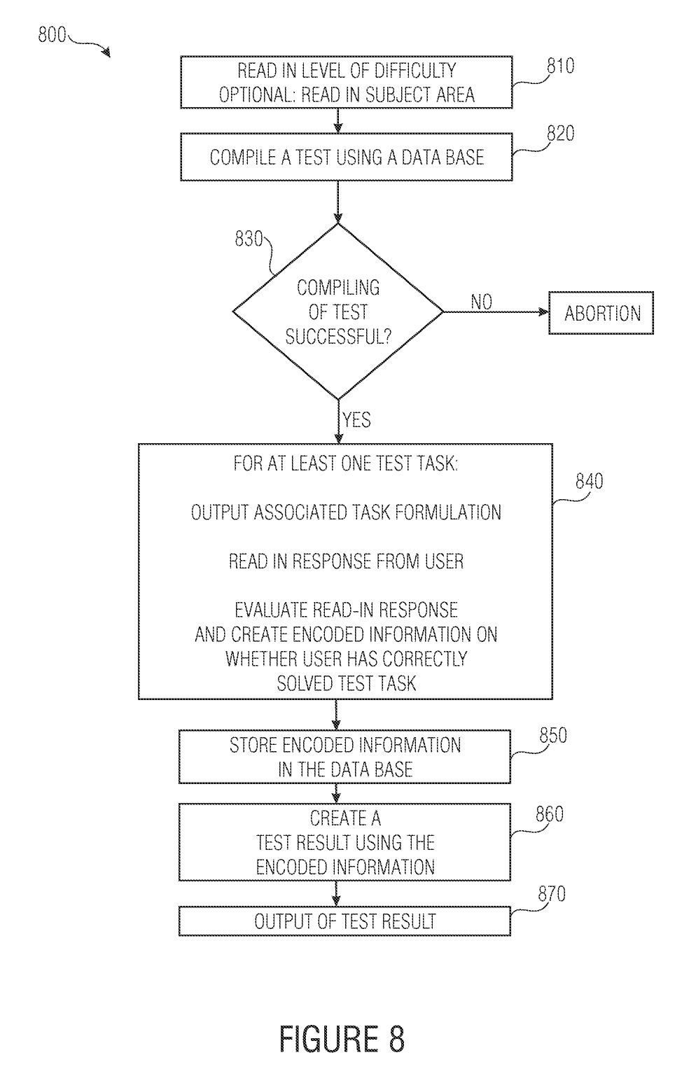

FIG. 8 shows a flowchart of an inventive method for performing a test according to a fourth embodiment of the present invention. The method shown in FIG. 8 is in its entirety designated with 800 and describes a test execution.

Here, a level of difficulty is read in a first step 810. Furthermore, a subject area may also optionally be read in. It is to be noted, however, that reading in the level of difficulty may be omitted if only one single level of difficulty is possible in an electronic learning system, for example.

In a second step 820, a test is then compiled using a database of test tasks. The second step 820 may, for example, comprise a method 100 according to FIG. 1, a method 300 according to FIG. 3, a method 400A, 400B according to FIGS. 4A, 4B, a method 500 according to FIG. 5A, a method 600 according to FIG. 6A and/or a method 700 according to FIG. 7.

That is, in the second step 820, the test is compiled using a database, wherein exception handling is advantageously performed when, for a task type of the database to be considered, there is no test task available exhibiting a suitable level of difficulty and not yet correctly answered by a user.

In a third step 830, a further determination is made whether the test compilation is successful. If this is not the case, then the inventive method will be aborted. If the compilation of the test is, however, successful, the test will be conducted in a fourth step 840. For at least one test task, the setting of a task is output, for example, in a visual and/or acoustic form. Advantageously, the output of the test task comprises a visual output of a text, an image, a video, an animation and/or a VRML world (VRML=virtual reality modeling language), wherein a reference to the visualization to be output is stored in the database. Furthermore, it is advantageous to also output acoustical information to a user. Thus, the database serves to describe or manage, respectively, different multimedia-based sources for an output of the test task by cross-references. Here, the compilation of the test tasks in the step 820 provides a superordinated sequence control for outputting different multimedia-based contents. Thus, a test is compiled such in the step 820 that the result is a well-balanced output of multimedia-based contents, wherein at least one replacement rule determines the selection of test tasks and, therefore, the sequence of the multimedia-based communication between a human being and a machine.

Following outputting a task, a response from the user is read in. The read-in response is then advantageously evaluated by comparing the read-in response to a comparison-response information from the test-task database. The read-in response may, however, also be evaluated in another way, for example by involving a tutor or by inputting the read-in response to a neural net. This method is recommendable if a possible read-in response may be of high complexity due to the present test task and when, therefore, several possible correct responses exist. In evaluating the read-in response, a difference between the read-in response and a comparison response, which is stored in the database and pertains to the test task output, may be determined, wherein a read-in response is classified as correct when the difference is less than a given maximum permissible difference. Moreover, it may be assumed that a read-in response is only then correct if it matches the comparison response from the database pertaining to the test task output. Apart from that, an arbitrary method for determining the difference between two inputs may be used for determining the difference between the read-in response and a comparison response. A tolerance interval may, for example, be used for numerical inputs. In addition, one of several possible responses missing may be tolerated in questions where there are several possible responses, wherein the input is still regarded as correct. Based on the evaluation of the read-in response, encoded information is then generated regarding whether the user has correctly solved the test task.

Furthermore, it is to be noted that outputting a setting of a task, reading in a response, evaluating the read-in response and creating encoded information may be repeated for a plurality of test tasks, which are part of the test compiled in step 820.

The encoded information, which contains information on whether the user has correctly solved a test task, may then be stored in the database (either directly after execution of a test task or after execution of all test tasks pertaining to a test). The encoded information may then be stored in the database such that it is associated with a user when an electronic test system may be used by several users. The storing of the encoded information is effected in the step 850.

A test result may then be created in a further step 860, using the encoded information. The test result may, for example, carry information on how many tasks a user has solved correctly. The test result may further contain temporal information carrying a statement regarding how long a user has taken for working on a test, which deficits the examinee has and/or which subjects should be treated with priority so as to make up for these deficits. The temporal information may, for example, be ascertained by means of a timer, which is part of an apparatus for performing a test. In other words, the method for performing a test may comprise starting an electronic timer as well as reading out the electronic timer after completion of the last test task pertaining to a compiled test.

The test result may further be output visually and/or acoustically or in the form of a print-out to the user in a terminating step 870.

Thus, the inventive method 800 for performing a test may, therefore, serve to achieve that test tasks that have already been correctly answered are not used repeatedly in the case of a repeated execution of the method. The reason is that, in compiling the test in the step 820, the database is accessed, wherein the database comprises, among other things, information on whether a user has already successfully solved a test task. In the step 850, however, encoded information is stored in the database by means of evaluating a response read out by the user, wherein the information carries information on whether the user has already correctly solved the test task. Thus, the test compilation is altered for each repeated execution of the method 800, based on the responses read in by the user. As a result a test system is created which is matched to the requirements of the user, i.e., for example, that test tasks are not presented a second time. In contrast to conventional methods for test compilation, the inventive method 800 does not pose the problem that a test can no longer be executed as soon as the user has correctly solved all test tasks of only one task type. That is, by means of the inventive compilation of a test using a database and using exception handling, replacement test tasks may be identified for a task type for which no more test tasks are available. Replacement test tasks may thus be selected according to given replacement rules such that a well-balanced test may still be obtained.

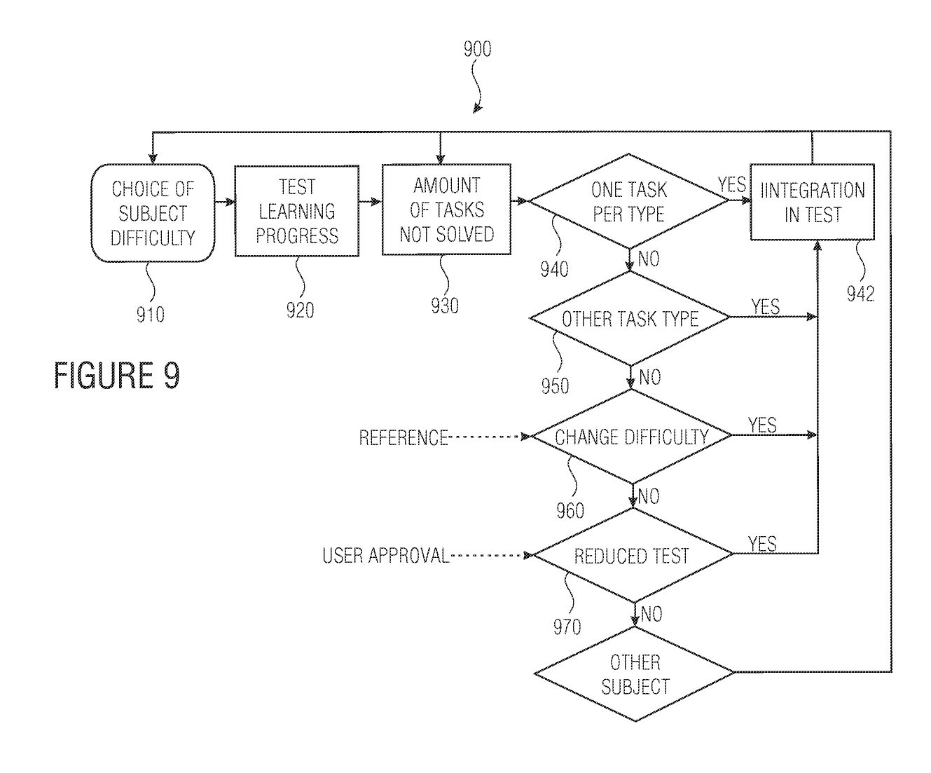

FIG. 9 shows a flowchart of an inventive method for performing a test according to a fifth embodiment of the present invention. Here, FIG. 9 describes the principle of dynamic test compilation. The method shown in FIG. 9 is in its entirety designated with 900 and in a first step 910 comprises reading in a subject area as well as reading in a level of difficulty.

Optionally, a number of test tasks to be executed may further be read in if same is not predetermined. The number of test tasks to be worked on may further be derived from received information on a number of test tasks to be solved. Thus, each institute may, for example, determine the number of test tasks per test as well as a level of difficulty. This results in the possibility of compiling tests from 20 tasks of the levels of difficulty 1 to 5 in a test execution in a first company (or on behalf of a first company), whereas tests consisting of 30 test tasks may be compiled in a second company.

Thus, means for receiving a number and a level of difficulty of the test tasks to be worked on in some cases provides added value as this enables simple adaptation of the inventive means to different applications in different test institutes (and/or in different companies). In the context of an exam situation, this is of particular advantage.

Based on the read-in subject area and the read-in level of difficulty, an examination of a successful learning process is prepared in a second step 920, whereupon a multitude of test tasks not yet solved is provided in a third step 930. Based on the tasks not yet solved provided in the third step 930, one task per task type is selected in a fourth step 940, if possible. If this is possible (positive or “yes”), the respective task will be incorporated into a test in a fifth step 942. However, if it is not possible to select one task per type in the fourth step 940 (negative or “no”), then an attempt will be made in a sixth step 950 to select a replacement task of another (replacement) task type. If this is possible (positive), then the replacement task will again be incorporated into the test in the fifth step 942. If it is not possible to find a replacement test task of another (replacement) task type in the sixth step 950, an attempt will be made to identify a replacement test task with another (replacement) level of difficulty in the database in a seventh step 960. If a test task with another (replacement) level of difficulty is identified in the database in the seventh step 960, a reference will be output to the user and the identified replacement test task will be incorporated into the test in the fifth step 942. If no replacement test task with another difficulty can be found in the seventh step 960 either (negative), an output to a user is effected in an eighth step 970. The user further reads in an input, which, depending on the contents, is valued as an approval (positive) or a rejection (negative) for an execution of a test with a reduced number of test tasks. If the input is such that it is valued as an approval, a reduced test will be compiled. If the user, however, does not agree to a reduced test in the eighth step 970 (negative), an output to the user is made requesting the user to select another subject area. As a response to the user's input an input of the user is then again read in the step 910, which enables selecting a subject area.

An inventive self-assessment-test environment therefore comprises, in contrast to known teaching/learning test systems, a wide range of task types for testing a successful learning process. Here, the task types may be classified as closed task types, half-open task types and open task types. Closed task types comprise, for example, multiple-choice tasks, true/false tasks, image selection, hotspots, rearrangement tasks and allocation tasks. Half-open task types may comprise, for example, image labeling and short text entries. Open tasks finally comprise, for example, making a sketch and extensive text entries. Each task type is advantageously stored in a separate table of the task database (database of test tasks), wherein, next to the task text, the solution reference, the subject reference, related subjects and the correct solution, response specifications may also be specified and/or stored in the database.

A combination of different task types allows combining the advantages with simultaneous compensation of the disadvantages. Furthermore, a variety of task types assists the formation and checking of different mental knowledge representations. According to a request for early, regular and individually adjustable monitoring of a successful learning progress, the self-assessment may be configured such that a time for performing a self-assessment test may be determined to be available. Tasks may be executed in arbitrarily selectable execution sequences and may further be arbitrarily viewed and/or edited. Furthermore, the contents of a self-assessment aspired for may either be pre-selected automatically or arbitrarily selected by a user. Furthermore, it is advantageous that three levels of difficulty are selectable (beginners, advanced and expert mode). In addition, a solution reference may be provided during execution of a test. Furthermore, it is advantageous to do without a time limitation, wherein it is advantageous, however, that an indication regarding exceeding a time limit is output. In addition, the working time necessitated may be indicated. Furthermore, it is advantageous to use approximately 15 tasks for one test so as to give a realistic idea of a successful learning progress and at the same time not overstrain a learner's or examinee's power of concentration. In an optional examination mode with approximately 20 tasks of different levels of difficulty, relevant modules and/or subject areas may further be automatically selected. In addition, tasks already executed are advantageously marked. Effective assistance may be ensured by outputting to a user references for operating the self-assessment as well as for the user inputs necessitated. This avoids cognitive overstraining given the diversity of task types.

An inventive dynamic compilation of the individual tests has the following advantages:

reusability of the tasks
variation of tests across several subject areas (modules)
degrees of freedom for the authors (number of tasks, editing, etc.).

In the context of the inventive dynamic approach there may occur or already exist the problem of admitting repetitions in the presentation and/or selection of tasks. The appropriate approach involves the decision to repeatedly present incorrectly solved tasks only. As a result, additional meta-data are stored, which determine the underlying data for the test:

subject area and level of difficulty of the task as well as

indication of successful learning progress for the respective user.

Therefore, the inventive algorithm of the dynamic test compilation checks the successful learning progress of the user for each task. First, one task per task type is randomly selected from the multitude of tasks not yet solved under consideration of the meta-data so as to obtain a well-balanced mix of task types. If a suitable task for a task type is found, a method described above is executed, wherein the user may, for example, be informed on the respective method steps by respective outputs, and wherein a user's approval may furthermore be read in by respective inputs.

An evaluation of the self-assessment test is also effected dynamically. In this context, the feedback fulfils a double task:

correction and supplementation of knowledge and
indication of strengths and weaknesses.

According to this, the examinee or the learner is advantageously provided with the following information:

complete task text and learner's response
evaluation of the response and correct response
working time and number of correctly solved tasks
hypertext reference to subjects not mastered, wherein cutting back on knowledge deficiencies may also be effected via a communication environment by means of accessing the distributed knowledge of the group.

Furthermore, it is to be noted that the method described may just as well be executed by a respective apparatus. Furthermore, the inventive method may, depending on the circumstances, be implemented in hardware or in software. The implementation may be effected on a digital storage medium, such as a floppy disc, a CD, a DVD or a flash memory medium, with electronically readable control signals cooperating such with a programmable computer system that the respective method is executed. In general, the invention also consists in a computer program product with a program code for performing the inventive method stored on a machine-readable carrier when the computer program product runs on a computer. In other words, the invention may, therefore, be realized as a computer program with a program code for performing the method when the computer program runs on a computer.

Furthermore, the present invention may be executed on a server computer exchanging data with one or more associated client computers. On the client computer, a dedicated application program for a retrieval of data from the server may run. On the other hand, a standard program for the representation of multimedia-based contents such as a web browser may run on the client computer. Therefore, a rendition of the information to be output can, therefore, be effected either in the client computer or in the server computer. Such realizations of the present invention may be considered as a server design or a client-server design.

The inventive method for compiling a test as well as for performing the test is, therefore, advantageous in that an optimally well-balanced test may be compiled even if not enough test tasks, or none at all, respectively, of a certain task type are available in a database.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1-29. (canceled)

30. An apparatus for compiling a test, comprising:
a database comprising a plurality of test tasks stored therein, wherein each test task is associated with a task type of a plurality of task types;
a selector for selecting test tasks from the database so as to achieve a multitude of selected test tasks for the test, wherein the selector for selecting test tasks comprises:
a selector for selecting, for a task type of the plurality of task types, at least one test task from the database, and for taking the selected test task over to a multitude of selected test tasks if a test task for the task type is available in the database; and
an exception handling logic adapted to search the database for a replacement test task according to a given replacement rule for a task type from the plurality of task types for which no test task is available in the database and take same over to the multitude of selected test tasks if there is a test task satisfying the replacement rule in the database; and
an outputter for outputting the selected test tasks of the test to a user.

31. The apparatus according to claim 30, wherein the apparatus for compiling a test further comprises an availability controller adapted to ensure that the selector for selecting at least one test task from the database does not recognize a test task identified as already successfully solved by a user by the availability control as being available.

32. The apparatus according to claim 31, wherein the availability controller is adapted to add to the database user-related information indicating that the user has successfully solved a certain test task when the availability control recognizes that the user has successfully solved the certain test task.

33. The apparatus according to claim 31, wherein the availability controller is adapted to delete a certain test task from the database when the availability control recognizes that the user has successfully solved the certain test task.

34. The apparatus according to claim 30, further comprising a receiver for receiving a nominal level of difficulty, wherein each test task is further associated with a level of difficulty, and wherein the apparatus for compiling the test further comprises a difficulty controller adapted to ensure that the selector for selecting at least one test task from the database recognizes as available only a test task the associated level of difficulty of which deviates from the nominal level of difficulty by a given level-of-difficulty deviation at the most.

35. The apparatus according to claim 30, wherein the replacement rule is adapted to instruct the exception handling logic to determine, for a task type from the plurality of task types for which no test task is available in the database, a replacement task type and search the database for a replacement test task with the replacement task type and take same over to the multitude of selected tasks.

36. The apparatus according to claim 35, wherein the exception handler is adapted to determine, for the task type for which no test task is available in the database, the replacement task type by accessing a task-type replacement table.

37. The apparatus according to claim 35, wherein each task type of the plurality of task types has associated with it a task-type feature vector describing features of the task type, and wherein the exception handler is adapted to determine, for the task type for which no test task is available in the database, a replacement task type such that task-type feature vectors of the task type for which no test task is available in the database and of the replacement task type differ as little as possible.

38. The apparatus according to claim 30, wherein each test task has associated with it a level of difficulty, which further comprises a receiver for receiving a nominal level of difficulty, and wherein the replacement rule is further adapted to instruct the exception handling logic to ascertain, based on the nominal level of difficulty, a replacement level of difficulty, to search for a replacement test task the level of difficulty of which deviates from the replacement level of difficulty by a given level-of-difficulty deviation at the most, for the task type from the plurality of task types for which no test task with the nominal level of difficulty is available in the database, and to take the replacement test task over to the multitude of selected tasks.

39. The apparatus according to claim 38, wherein the exception handling logic is further adapted to output to the user a message comprising information on a use of the replacement level of difficulty.

40. The apparatus according to claim 38, wherein the replacement rule is adapted to instruct the exception handling logic to determine, based on the nominal level of difficulty, a replacement level of difficulty and search for a replacement test task using the replacement level of difficulty only if no replacement test task of a replacement task type and of the nominal level of difficulty is available in the database.

41. The apparatus according to claim 30, wherein the exception handling logic further comprises an enquirer adapted to output a message to the user if there is no test task satisfying the replacement rule for a task type for which no test task is available in the database.

42. The apparatus according to claim 41, wherein the enquirer is further adapted to receive an input from the user, and wherein the exception handling logic is further adapted, depending on the input to either create a shortened test or output a message to a user, to receive a second input from the user and use the second input for selecting a different subject area,
wherein the exception handling logic creates a shortened test by the exception handling logic making the hitherto existing multitude of selected tasks available for a test execution without determining a replacement task for the task type for which no test task is available in the database and for which there is no test task in the database satisfying the replacement rule.

43. The apparatus according to claim 30, wherein the selector for selecting at least one test task from the database is adapted to select, from the database, for a task type from the plurality of task types, a given number of test tasks pertaining to the task type if a sufficient number of test tasks for the task type are available in the database.

44. The apparatus according to claim 43, wherein the selector for selecting at least one test task from the database is adapted to read out the given number of test tasks pertaining to the task type from a look-up table.

45. The apparatus according to claim 43, wherein the apparatus further comprises a receiver for receiving information on the given number, which is adapted to determine the given number based on the information on the given number.

46. The apparatus according to claim 30, wherein the selector for selecting at least one test task for a task type of the plurality of task types is adapted to randomly select at least one test task for the task type from the database if at least two test tasks for the task type are available in the database.

47. The apparatus according to claim 46, wherein the selector for selecting at least one test task for a task type of the plurality of task types comprises a random number generator and is further adapted to use a random number provided by the random number generator for the random selection of the test task.

48. The apparatus according to claim 30, wherein, for each test task in the database, there is deposited a type identifier comprising a data symbol encoding the task type of the test task, and/or a level-of-difficulty identifier comprising a numerical value describing a level of difficulty of a test task, and/or a subject-area identifier comprising a data symbol encoding a subject area of the test task, and/or a solved identifier comprising a data symbol providing a statement on whether a user has already solved the test task, and/or a text field comprising text pertaining to the test task stored therein, and/or a reference field comprising a reference to a storage location of more profound information pertaining to the test task stored therein, and/or a time field comprising a time period intended for the test task stored therein in encoded form, and/or an error counter field comprising a number of unsuccessful solution attempts of a user stored therein in encoded form.

49. The apparatus according to claim 30, wherein the outputter for outputting the selected tasks of the test to the user is adapted to output the selected tasks, using the database, visually and/or acoustically and/or as a print-out.

50. A method for compiling a test using a database having a plurality of test tasks stored therein, wherein each test task is associated with a task type of a plurality of task types, comprising:
selecting test tasks from the database so as to achieve a multitude of selected test tasks for the test, wherein the selecting of test tasks comprises:
selecting, for a task type of the plurality of task types, at least one test task from the database and taking the selected test task over to the multitude of selected test tasks if a test task for the task type is available in the database; and
performing exception handling for a task type from the plurality of task types for which no test task is available in the database, wherein the performing of the exception handling comprises searching the database, according to a given replacement rule, for a replacement test task for the task type for which no test task is available in the database as well as, if there is a test task satisfying the replacement rule in the database, taking the replacement test task over to the multitude of selected tasks; and
outputting the selected tasks of the test to a user.

51. A computer readable medium storing a computer program, when run on a computer, the computer program performs a method for compiling a test using a database having a plurality of test tasks stored therein, wherein each test task is associated with a task type of a plurality of task types, comprising:
selecting test tasks from the database so as to achieve a multitude of selected test tasks for the test, wherein the selecting of test tasks comprises:
selecting, for a task type of the plurality of task types, at least one test task from the database and taking the selected test task over to the multitude of selected test tasks if a test task for the task type is available in the database; and
performing exception handling for a task type of the plurality of task types for which no test task is available in the database, wherein the performing of the exception handling comprises searching the database, according to a given replacement rule, for a replacement test task for the task type for which no test task is available in the database, as well as, if there is a test task satisfying the replacement rule in the database, taking the replacement test task over to the multitude of selected tasks; and
outputting the selected tasks of the test to a user.

52. An apparatus for testing an examinee, comprising:
an apparatus for compiling a test, comprising:
a database having a plurality of test tasks stored therein, wherein each test task is associated with a task type of a plurality of task types;
a selector for selecting test tasks from the database so as to achieve a multitude of selected test tasks for the test, wherein the selector for selecting test tasks comprises:
a selector for selecting, for a task type of the plurality of task types, at least one test task from the database, and for taking the selected test task over to a multitude of selected test tasks if a test task for the task type is available in the database; and
an exception handling logic adapted to search the database for a replacement test task according to a given replacement rule for a task type of the plurality of task types for which no test task is available in the database and take same over to the multitude of selected test tasks if there is a test task satisfying the replacement rule in the database; and
an outputter for outputting the selected test tasks of the test to a user;
a reader for reading in a response to at least one of the selected test tasks output by the apparatus for compiling the test;
an evaluator for evaluating the read-in response so as to achieve encoded information on whether the read-in response represents a correct solution of the selected test tasks output; and
an outputter for outputting a test result in dependence on the encoded information.

53. The apparatus according to claim 52, wherein the apparatus for compiling a test further comprises an availability controller adapted to ensure that the selector for selecting at least one test task from the database does not recognize a test task identified as already successfully solved by a user by the availability control as being available, wherein the availability controller is adapted to evaluate the encoded information on whether the read-in response represents a correct solution of the selected test task output so as to identify a test task as already successfully solved by a user or as not yet successfully solved by a user.

54. The apparatus according to claim 52, further comprising a storage adapted to store the encoded information in a database in a user-related manner.

55. The apparatus according to claim 52, wherein the evaluator for evaluating the read-in response comprises a comparator adapted to compare the read-in response with a comparison response stored in the database and pertaining to the selected test task output and to evaluate the read-in response as a correct response when the read-in response exhibits a given deviation from the comparison response at the most so as to provide, for the test task output, encoded information corresponding to the comparison result.

56. The apparatus according to claim 52, wherein the evaluator for evaluating the read-in responses comprises a comparator adapted to compare the read-in response to a comparison response stored in the database and pertaining to the selected test task output so as to evaluate the read-in response as a correct response when the read-in response matches the comparison response and to provide, for the test task output, encoded information corresponding to the comparison result.

57. A method for testing an examinee, comprising:
compiling a test using a database having a plurality of test tasks stored therein, wherein each test task is associated with a task type of a plurality of task types, comprising:
selecting test tasks from the database so as to achieve a multitude of selected test tasks for the test, wherein the selecting of test tasks comprises:
selecting, for a task type of the plurality of task types, at least one test task from the database and taking the selected test task over to the multitude of selected test tasks if a test task for the task type is available in the database; and
performing exception handling for a task type of the plurality of task types for which no test task is available in the database, wherein the performing of the exception handling comprises searching the database, according to a given replacement rule, for a replacement test task for the task type for which no test task is available in the database, as well as, if there is a test task satisfying the replacement rule in the database, taking the replacement test task over to the multitude of selected tasks; and
outputting the selected tasks of the test to a user;
reading in a response to one of the selected test tasks output;
evaluating the read-in response so as to achieve encoded information on whether the read-in response is a correct solution of the selected test task output; and
outputting a test result in dependence on the encoded information.

58. A computer readable medium storing a computer program, when run on a computer, the computer program performs a method for testing an examinee, comprising:
compiling a test using a database having a plurality of test tasks stored therein, wherein each test task is associated with a task type of a plurality of task types, comprising:
selecting test tasks from the database so as to achieve a multitude of selected test tasks for the test, wherein the selecting of test tasks comprises:
selecting, for a task type of the plurality of task types, at least one test task from the database and taking the selected test task over to the multitude of selected test tasks if a test task for the task type is available in the database; and
performing exception handling for a task type of the plurality of task types for which no test task is available in the database, wherein the performing of the exception handling comprises searching the database, according to a given replacement rule, for a replacement test task for the task type for which no test task is available in the database, as well as, if there is a test task satisfying the replacement rule in the database, taking the replacement test task over to the multitude of selected tasks; and
outputting the selected tasks of the test to a user;
reading in a response to one of the selected test tasks output;
evaluating the read-in response so as to achieve encoded information on whether the read-in response is a correct solution of the selected test task output; and
outputting a test result in dependence on the encoded information.
